(19) United States
(12) Patent Application Publication
(10) Pub. No.: US 2023/0089307 A1
(43) Pub. Date: Mar. 23, 2023

(54) Extended Reality Safety and Accessibility Assistant

(71) Applicant: AT&T Intellectual Property l, L.P., Atlanta, GA (US)

(72) Inventors: Brianna King, Suwanee, GA (US); Brittany Clarke, Cumming, GA (US); Patricia Devere, Warrenton, VA (US); Michele Smith, Castle Rock, CO (US)

(73) Assignee: AT&T Intellectual Property l, L.P., Atlanta, GA (US)

(21) Appl. No.: 17/478,315

(22) Filed: Sep. 17, 2021

(51) Int. Cl. G06K 9/00; H04L 29/06; G06K 9/32; G06N 5/02; G06F 16/2457

(52) U.S. Cl. CPC G06K 9/00671; H04L 67/38; G06K 9/00979; G06K 9/3241; G06N 5/022; G06F 16/24578

(57) ABSTRACT

Concepts and technologies are disclosed herein for an extended reality safety and accessibility assistant. According to one aspect disclosed herein, a server computer can include a processor and a memory. The memory can include instructions that, when executed by the processor, cause the processor to perform operations. In particular, the server computer can receive a request from a user device. The request can include an image of a physical environment. The server computer can identify a structure within the image and can determine whether the structure is associated with a safety rating, an accessibility rating, or both. In response to determining that the structure is associated with a rating, the server computer can generate extended reality display data including an augmented reality object that is representative of the rating.

### BACKGROUND

Each day, families across the world visit parks, recreation centers, campgrounds, and other public locations to enjoy quality family time with their loved ones. The physical structures (e.g., playground equipment, benches, bridges, and the like) and areas of interest (e.g., trails, sidewalks, parking lots, sports fields, and the like) within these facilities may have signs that warn users to use at their own risk, but offer little to no insight into reliability, condition, and/or accessibility thereof. As such, these families must blindly trust that the owner, operator, municipality, or other entity that oversees these facilities is following all recommended safety procedures, performing any necessary maintenance, and replacing worn or otherwise faulty equipment to ensure the safety of the users.

### SUMMARY

Concepts and technologies are disclosed herein for an extended reality safety and accessibility assistant. According to one aspect disclosed herein, a server computer can include a processor and a memory. The memory can include instructions that, when executed by the processor, cause the processor to perform operations. In particular, the server computer can receive a request from a user device. The request can include an image of a physical environment. The server computer can identify a structure within the image and can determine whether the structure is associated with a safety rating, an accessibility rating, or both. The structure can be, for example, a playground equipment, a sports equipment, an exercise equipment, a seat (e.g., bleachers or a bench), other manufactured structures (e.g., shelter), and the like. In some embodiments, the server computer can determine whether the structure is associated with a rating by querying a ratings database. The ratings database can include a plurality of ratings, including safety ratings and/or accessibility ratings, for a plurality of structures. The plurality of ratings can be determined, at least in part, based upon a machine learning model. The machine learning model can be created based upon one or more training data sets. In response to determining that the structure is associated with a rating, the server computer can generate extended reality display data including an augmented reality object that is representative of the rating. If the structure is not associated with a rating, the server computer can utilize a predictive machine learning model to assign an appropriate rating. The server computer can generate extended reality display data including an augmented reality object that is representative of this rating. The server computer can provide the extended reality display data to the user device. The user device, in turn, can present the augmented reality object. In some embodiments, the augmented reality object can be presented as an overlay of the image of the physical environment.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

Other systems, methods, and/or computer program products according to embodiments will be or become apparent to one with skill in the art upon review of the following drawings and detailed description. It is intended that all such additional systems, methods, and/or computer program products be included within this description, be within the scope of this disclosure.

### BRIEF DESCRIPTION OF THE DRAWINGS

FIG. 1 is a system diagram illustrating an illustrative operating environment for various embodiments of the concepts and technologies described herein.

FIG. 2 is a user interface diagram showing a screen display for providing extended reality display data, according to an illustrative embodiment of the concepts and technologies described herein.

FIG. 3 is a flow diagram showing aspects of a method for requesting and presenting extended reality display data for an existing physical environment, according to an illustrative embodiment of the concepts and technologies described herein.

FIG. 4 is a flow diagram showing aspects of a method for requesting and presenting extended reality display data for a future physical environment, according to an illustrative embodiment of the concepts and technologies disclosed herein.

FIG. 5 is a flow diagram showing aspects of a method for generating and providing extended reality display data for an existing physical environment, according to an illustrative embodiment of the concepts and technologies described herein.

FIG. 6 is a flow diagram showing aspects of a method for generating and providing extended reality display data for a future physical environment, according to an illustrative embodiment of the concepts and technologies described herein.

FIG. 7 schematically illustrates a network, according to an illustrative embodiment of the concepts and technologies described herein.

FIG. 8 is a block diagram illustrating an example computer system capable of implementing aspects of the embodiments presented herein, according to some illustrative embodiments of the concepts and technologies described herein.

FIG. 9 is a block diagram illustrating an example mobile device capable of implementing aspects of the embodiments presented herein, according to some illustrative embodiments of the concepts and technologies described herein.

FIG. 10 is a block diagram illustrating an example machine learning system capable of implementing aspects of the embodiments presented herein.

### DETAILED DESCRIPTION

The concepts and technologies disclosed herein provide a safety and accessibility assistant service that can provide extended reality display data to users such as park owners, manufacturers, designers, construction companies, and the like, as well as general users. In some embodiments, the safety and accessibility assistant obtains an image associated with an existing physical environment (e.g., a playground) and performs an analysis to determine safety and/or accessibility ratings for any structure(s) and/or area(s) of interest associated with the existing physical environment. In some embodiments, the safety and accessibility assistant obtains a blueprint/design for a future physical environment (e.g., a future playground) and performs an analysis to determine safety and/or accessibility ratings for any proposed structure(s) and/or area(s) of interest associated with the proposed future physical environment.

The analyses described herein can incorporate historical injury data from a secure database, materials used and the respective capacities and absorbance measures via publicly accessible information from the Internet, the component spacing with respect to each area of a setting (e.g., trail spacing, sidewalk width, monkey bar spacing on a playground, bridge railing or bridge material capacity, and the like), and overall design capabilities. Based upon these analyses, an easy-to-view feedback of areas and/or structures can be provided based upon the type of input (i.e., blueprint or image). If the input is an image of an existing physical environment that contains one or more structures and/or one or more areas of interest, a safety rating and/or an accessibility rating can be provided as an augmented reality object. If the input is a blueprint for a future physical environment that contains one or more structures and/or one or more areas of interest, a safety rating and/or accessibility rating can be provided as a virtual reality object within a virtual representation of the future physical environment.

Based on the materials used in existing physical environments or anticipated within digital designs, the feedback and explanations may provide material suggestions based on quality rating provided from image, pixelated analysis, and safety information accumulated and stored on various servers. Ratings, publicized data, and geofencing technology can be combined, utilized, and stored to offer a search feature that displays information about a given location prior to visiting a particular site as well. This is an improvement on a variety of equipment and parks, especially compared to existing safety rating of playground equipment, as most provide ratings based on user bias and simple feedback forms, then apply these to a larger scope of equipment materials.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

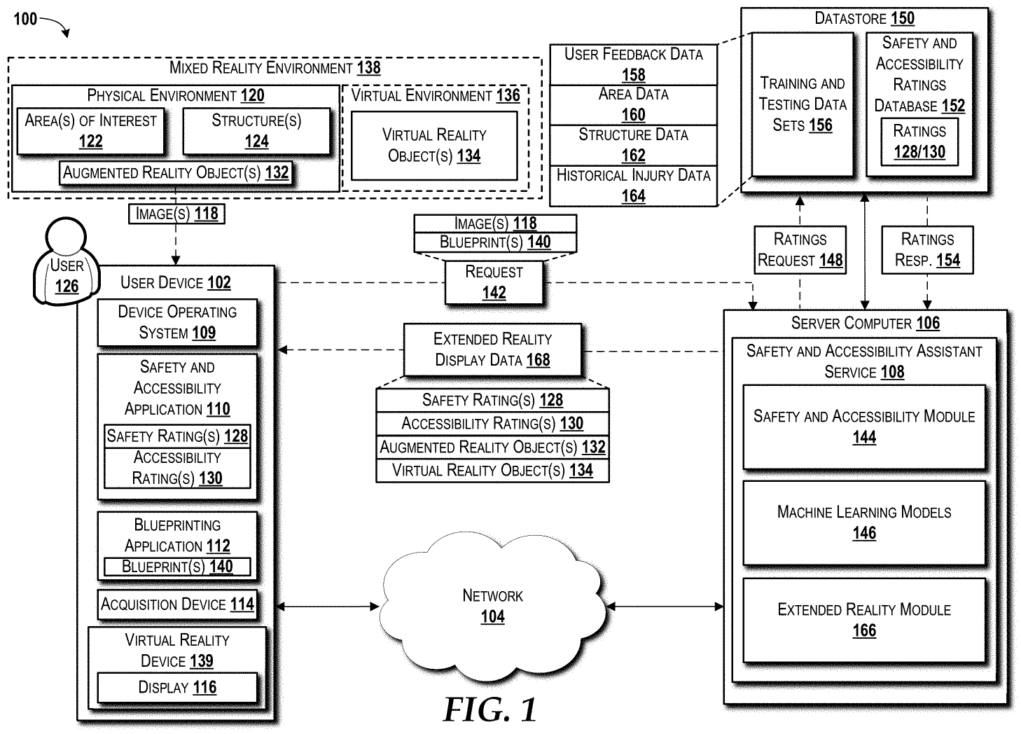

Referring now to FIG. 1, aspects of an operating environment 100 in which various embodiments of the concepts and technologies disclosed herein can be implemented will be described, according to an illustrative embodiment. The operating environment 100 includes a user device 102 that can operate in communication with and/or as part of a communications network (“network”) 104. In some embodiments, the user device 102 can communicate with a server computer 106, and particularly, a safety and accessibility assistant service 108 that is provided, at least in part, by the server computer 106 to perform operations disclosed herein. Although the safety and accessibility assistant service 108 is described herein as being provided, at least in part, by the server computer 106, it should be understood that the user device 102, additionally or alternatively, can provide at least some of the functionality described herein as part of the safety and accessibility assistant service 108. Accordingly, the user device 102 can operate in a connected mode or an unconnected mode. The connected mode can enable the user device 102 to communicate with the server computer 106 over the network 104 to access the functionality provided by the safety and accessibility assistant service 108. The unconnected mode can enable the user device 102 to access the functionality provided by the safety and accessibility assistant service 108 when connectivity to a network, such as the network 104, is unavailable.

According to various embodiments, the functionality of the user device 102 may be provided by one or more server computers, personal digital assistants (“PDAs”), tablet computers, slate computers, smart watches, smart glasses (e.g., the GOOGLE GLASS family of products), mobile media devices, mobile telephones, laptop computers, smartphones, a wearable computing device, a heads-up display computer system, a vehicle computing system, an attachable computing device, a camera, an appliance (e.g., a refrigerator, an oven, a microwave, etc.), a television, a handheld device, a mirror, a window, other computing systems/devices, and the like. It is understood that the examples discussed above are used for illustration purposes only, and therefore should not be construed to limit the scope of the disclosure in any way. It should be understood that the functionality of the user device 102 can be provided by a single device, by two similar devices, and/or by two or more dissimilar devices. For purposes of describing the concepts and technologies disclosed herein, the user device 102 is described herein as a smartphone. It should be understood that this embodiment is illustrative, and should not be construed as being limiting in any way.

The user device 102 can execute a device operating system 109 and one or more application programs such as a safety and accessibility application 110 and a blueprinting application 112 in the illustrated example. The user device 102 can execute one or more other application programs (not shown in FIG. 1), such as, but not limited to, web browsers, web applications, mail applications, native applications, media applications, camera and/or video applications, combinations thereof, or the like. The device operating system 109 is a computer program for controlling the operation of the user device 102. The safety and accessibility application 110, the blueprinting application 112, and the other application program(s) can include executable instructions configured to execute on top of the device operating system 109 to provide various functions illustrated and described herein.

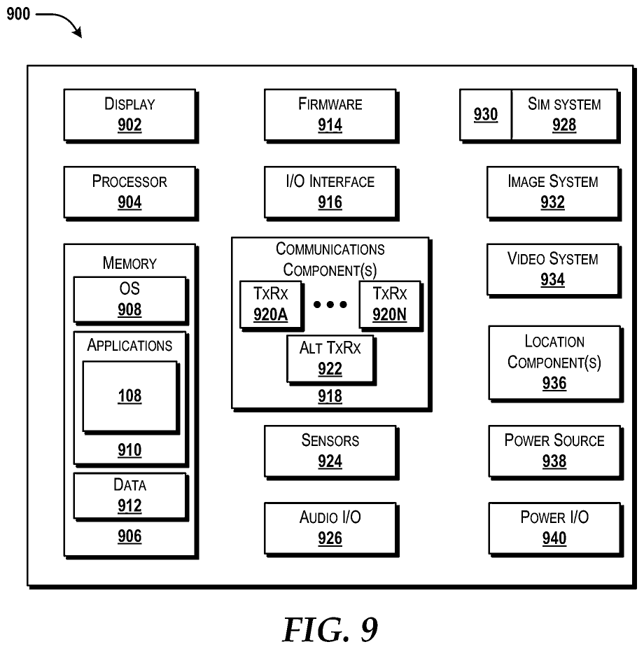

The user device 102 also includes an acquisition device 114 and a display 116. The acquisition device 114 can be or can include one or more still cameras and/or one or more video cameras, examples of which are illustrated and described herein with reference to FIG. 9, and particularly, an image system 932 and a video system 934, respectively. The acquisition device 114 can obtain one or more images 118 of a physical, real-world environment 120 (“physical environment 120”). The images 118 can be live images (e.g., live video) or non-live images (e.g., recorded video or photograph) that can be presented on the display 116. The physical environment 120 can be or can include any location, building, property, grounds, or the like. The physical environment 120 can include one or more areas of interest 122, such as, but not limited to, roads, sidewalks, fields (e.g., grass, artificial turf, and/or dirt), bodies of water, plants, hardscape, and the like. The physical environment 120 can also include one or more structures 124, such as, but not limited to, playground equipment, sports equipment, exercise equipment, seating, other manufactured structures, and the like.

In some embodiments, a user 126 can launch or otherwise initiate the safety and accessibility application 110 for execution by the user device 102. The user 126 may launch the safety and accessibility application 110 in order to use the safety and accessibility application 110 to help determine safety rating(s) 128 and/or accessibility rating(s) 130 for the physical environment 120, one or more of the areas of interest 122, and/or one or more of the structures 124. The safety rating(s) 128 and/or the accessibility ratings(s) 130 can be presented to the user 126 visually (e.g., via the display 116), audibly (e.g., via an audio output best shown as audio I/O 926 in FIG. 9), or both.

The safety rating(s) 128 can provide insight to the user 126 with regard to the safety of the physical environment 120, the area(s) of interest 122, and/or the structure(s) 124. The safety rating(s) 128 can be provided by any rating system. For example, the safety rating(s) 128 can be provided by a scale-based rating system such as, but not limited to, a number scale (e.g., 0-5 with 0 being the worst and 5 being the best), a letter scale (e.g., A, B, C, D, and F), or a descriptive scale (e.g., “Safe,” “Unsafe: Do Not Use,” “Use Caution,” or the like). Other ways in which the safety rating(s) 128 can be expressed are contemplated, and as such, the examples disclosed herein should not be construed as being limiting in any way. Moreover, the safety rating(s) 128 can be based upon the same or different ratings systems for the physical environment 120, the area(s) of interest 122, and/or the structure(s) 124.

The accessibility rating(s) 130 can provide insight to the user 126 with regard to the accessibility of the physical environment 120, the area(s) of interest 122, and/or the structure(s) 124. The accessibility rating(s) 130 can be provided by any rating system. For example, the accessibility rating(s) 130 can be provided by a scale-based rating system such as, but not limited to, a number scale (e.g., 0-5 with 0 being the worst and 5 being the best), a letter scale (e.g., A, B, C, D, and F), or a descriptive scale (e.g., “Full Accessibility,” “Limited Accessibility,” or the like). Other ways in which accessibility rating(s) 130 can be expressed are contemplated, and as such, the examples disclosed herein should not be construed as being limiting in any way. Moreover, the accessibility rating(s) 130 can be based upon the same or different ratings systems for the physical environment 120, the area(s) of interest 122, and/or the structure(s) 124.

In some embodiments, the safety rating(s) 128 and/or the accessibility rating(s) 130 can be presented as augmented reality object(s) 132. “Augmented reality” is used herein to describe a computing concept in which at least a portion of a physical, real-world environment, such as the physical environment 120, is augmented to include computer-generated data that is presented as an overlay of and/or spatially integrated with content on a display, such as the display 116. The computer-generated data can include virtual objects (i.e., the augmented reality object(s) 132) that are presented over and/or spatially integrated with real-world objects, such as the area(s) of interest 122 and/or the structure(s) 124 of the physical environment 120, on the display 116. The augmented reality object(s) 132 can include text, colors, patterns, gradients, graphics, other images, videos, animations, combinations thereof, and the like. Computer-generated data that augments in some manner a view of a physical, real-world environment, such as the physical environment 120, and/or elements thereof, such as such as the area(s) of interest 122 and/or the structure(s) 124, is referred to herein generally as “augmentation” (or variants thereof, such as “augmenting”).

In some embodiments, the safety rating(s) 128 and/or the accessibility rating(s) 130 can be presented as virtual reality object(s) 134. “Virtual reality” is used herein to describe a computing concept in which a computer-generated environment (also referred to herein as a “virtual environment 136”) is created for a user, such as the user 126, to explore. The virtual environment 136 can include a computer-generated representation or at least an approximation of at least a portion of a physical, real-world environment, such as the physical environment 120. The virtual environment 136 can be or can include the virtual reality object(s) 134. The virtual environment 136 can be at least partially different from the physical environment 120 of which the virtual environment 136 is representative. The virtual environment 136 can include virtual reality objects 134 not found in the corresponding physical environment 120. Lighting effects such as light bloom and other effects such as depth-of-field can be applied to the virtual environment 136 to create atmosphere. Moreover, natural phenomena such as gravity and momentum can be simulated in the virtual environment 136. These natural phenomena can be simulated, for example, when the user 126 interacts with the virtual environment 136.

In some embodiments, the safety rating(s) 128 and/or the accessibility rating(s) 130 can be presented as part of a mixed reality environment 138 that can include one or more elements of the physical environment 120 (such as the area(s) of interest 122 and/or the structure(s) 124) and one or more elements of the virtual environment 136 (such as the virtual reality object(s) 134). The concepts of augmented reality, virtual reality, and mixed reality can be referred to collectively as “extended reality.”

As noted above, the image(s) 118 can be live images (e.g., live video or photograph) or non-live images (e.g., recorded video or photograph) that can be presented on the display 116. The image(s) 118 as live image(s) can be presented on the display 116 in real-time as the acquisition device 114 captures a live view of the physical environment 120. The user device 102 can execute the safety and accessibility application 110 to obtain the safety rating(s) 128 and/or the accessibility rating(s) 130 in the form of the augmented reality object(s) 132 for presentation as augmentations to the physical environment 120 shown in the live view of the image(s) 118. The image(s) 118 as non-live image(s) can be presented on the display 116 in non-real-time (e.g., after the acquisition device 114 captures the image(s) 118). The user device 102 can execute the safety and accessibility application 110 to obtain the safety rating(s) 128 and/or the accessibility rating(s) 130 in the form of the augmented reality object(s) 132 for presentation as augmentations to the physical environment 120 shown in the non-live view of the image(s) 118.

In some embodiments, the safety and accessibility application 110 can also enable the user 126 to view the virtual environment 1136 that contains the virtual reality object(s) 134 such as computer-generated representations of the physical environment 120, the area(s) of interest 122, and/or the structure(s) 124 and the safety rating(s) 128 and/or accessibility rating(s) 130 associated therewith. In these embodiments, a virtual reality device 139 can be used by the user 126 to view the virtual environment 136. The virtual reality device 139 can include one or more displays, such as the display 116 and/or one or more other distinct displays. The display 116 and/or the other distinct display(s) can be an integrated display, a head-mounted display, an eyeglasses display, a head-up display, an external display, a projection display, a combination thereof, and/or the like. The virtual reality device 139 can include one or more input devices such as controllers, joysticks, haptic devices, motion sensors, a combination thereof, and/or the like. In some embodiments, the virtual reality device 139 is OCULUS RIFT or OCULUS QUEST (available from OCULUS VR), SAMSUNG GEAR VR (available from SAMSUNG and OCULUS VR), GOOGLE CARDBOARD (available from GOOGLE), HTC VIVE (available from HTC), SONY PLAYSTATION VR (available from SONY), VALVE INDEX (Available from VALVE), HP REVERB (available from HP), variations thereof, and/or the like.

The virtual environment 136 can include a virtual representation of the physical environment 120 in a present state, past state, or future state. In some embodiments, the virtual environment 136 represents the physical environment 120 during a design phase for a future state of the physical environment 120. In these embodiments, the user device 102 can execute the blueprinting application 112, which can provide the virtual environment 136 as output to the virtual reality device 139 to enable the user 126 to view and interact with the virtual environment 136 to design a blueprint 140 for the physical environment 120 including a design of the area(s) of interest 122 and/or the structure(s) 124 using the virtual reality object(s) 134 as virtual representations thereof. The virtual reality object(s) 134 can additionally include the safety rating(s) 128 and/or the accessibility ratings(s) 130 such that during the design phase the user 126 can view the safety rating(s) 128 and/or the accessibility rating(s) 130 associated with the real-world counterparts to the virtual reality object(s) 134 that are representative of the area(s) of interest 122 and/or the structure(s) 124. In this manner, the user 126 can design the physical environment 120 to achieve certain safety and/or accessibility goals. The design can be saved as the blueprint 140 that can be viewed via the virtual reality device 139. After the physical environment 120 is created based upon the blueprint 140, the blueprint 140 can be used by the safety and accessibility application 110 to populate the safety rating(s) 128 and/or the accessibility rating(s) 130 as the augmented reality object(s) 132.

In some embodiments, the blueprinting application 112 can be an off-the-shelf design application. In some other embodiments, the blueprinting application 112 can be a proprietary design application. The blueprint 140 can include exact or estimated dimensions of the physical environment 120. In some embodiments, the user 126 can enter a location of the physical environment 120 such as an address or latitude/longitude coordinates to obtain the dimensions. In some embodiments, the blueprinting application 112 can provide a what-you-see-is-what-you-get (“WYSIWYG”) design mechanic whereby the user 126 can drag and drop the virtual reality object(s) 134 on a virtual canvas to layout the design for the physical environment 120. In some embodiments, the blueprinting application 112 can provide a manual design mechanic whereby the user 126 can draw representations of the area(s) of interest 122 and/or the structure(s) 124. It is contemplated that the blueprinting application 112 can obtain the image(s) 118 and the augmented reality object(s) 132 to create a new blueprint 140 or to modify an existing blueprint 140.

The safety and accessibility application 110 can generate a request 142 that is directed to the server computer 106, and particularly, the safety and accessibility assistant service 108. In some embodiments, the request 142 includes the image(s) 118 of the physical environment 120 in a present state (i.e., a live image) or in a past state (i.e., a non-live image). In some embodiments, the request 142 includes the blueprint(s) 140 of the physical environment 120. The safety and accessibility assistant service 108 can include a safety and accessibility module 144 that can perform processing operations such as object detection, feature extraction, object recognition, template matching, and/or combinations thereof. The safety and accessibility module 144 can identify objects, such as the area(s) of interest 122 and/or the structure(s) 124, within the image(s) 118. In some embodiments, the safety and accessibility module 144 can utilize one or more machine learning models 146 to perform, at least in part, the processing operations. For instance, a neural network or deep neural network may be implemented to perform, at least in part, the processing operations.

After the safety and accessibility module 144 identifies the area(s) of interest 122 and/or the structure(s) 124, the safety and accessibility module 144 can generate a ratings request 148 directed to a datastore 150. In the illustrated example, the datastore 150 is shown as being remote from the server computer 106, although the datastore 150 may be integrated as part of the server computer 106 in some implementations. The ratings request 148 can identify the area(s) of interest 122 and/or the structure(s) 124 for which the safety rating(s) 128 and/or the accessibility rating(s) 130 are desired. In response to receiving the ratings request 148, the datastore 150 can query a safety and accessibility ratings database 152 for the safety rating(s) 128 and/or the accessibility rating(s) 130 associated with the area(s) of interest 122 and/or the structure(s) 124. If the safety and accessibility ratings database 152 has the requested safety rating(s) 128 and/or accessibility rating(s) 130, the safety and accessibility ratings database 152 can respond to the query with a ratings response 154 that includes the requested safety rating(s) 128 and/or accessibility rating(s) 130. If, however, the safety and accessibility ratings database 152 does not have the requested safety rating(s) 128 and/or accessibility rating(s) 130, a rating (e.g., a safety and/or accessibility rating 128/130) may be generated via the machine learning model(s) 146 (e.g., one or more predictive machine learning models). If, however, the safety and accessibility ratings database 152 does not have the requested safety rating(s) 128 and/or accessibility rating(s) 130, and the machine learning model(s) 146 are unable to generate a rating (e.g., if the predicted rating is below a given threshold of confidence), the ratings response 154 can indicate that no safety rating(s) 128 and/or accessibility rating(s) 130 are available for the area(s) of interest 122 and/or the structure(s) 124. Alternatively, the ratings response 154 may include a default rating.

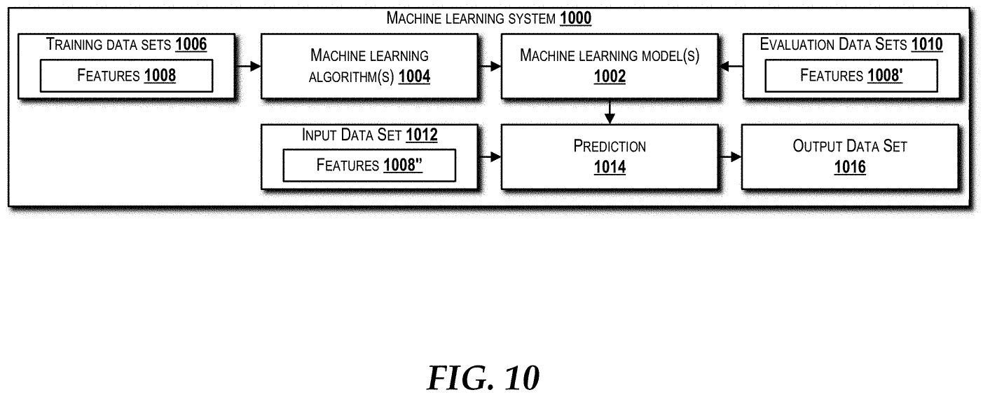

The safety and accessibility module 144 can use the machine learning models 146 to determine the safety rating(s) 128 and/or the accessibility rating(s) 130. In some embodiments, the machine learning models 146 can be trained by a machine learning system, such as via an example machine learning system 1000 illustrated and described herein with reference to FIG. 10, using training and testing data sets 156 to define the safety rating(s) 128 and/or the accessibility rating(s) 130. In the illustrated example, the training and testing data sets 156 can include user feedback data 158, area data 160, structure data 162, historical injury data 164, a combination thereof, and/or the like. The training and testing data sets 156 can start as one data set that includes both training data and testing data, then a 70/30 training/testing split can be applied to create an individual training data set and an individual testing data set. Alternatively, a different weighted split can be applied, such as, for example, a 60/40, 80/20, or 90/10 split. The machine learning models 146 can be trained on the training data set and evaluated for performance on the testing data set, which also contains feature details like in the training data set. Desired model performance found through model evaluation may be reached through repeated model training with adjusted model parameters until an evaluation threshold is reached.

The user feedback data 158 can include user ratings provided by users, such as the user 126. The user feedback data 158 can be requested, for example, when the user 126 is at the physical environment 120. In some embodiments, the user feedback data 158 is structured such that the user 126 can rate the area(s) of interest 122 and/or the structure(s) 124 based upon the perceived safety and/or accessibility thereof. For example, the safety and accessibility application 110 may prompt the user 126 to rate the area(s) of interest 122 and/or the structure(s) 124 based upon an established rating system (e.g., a rating scale). In other embodiments, the user feedback data 158 is unstructured such that the user 126 can rate the rate the area(s) of interest 122 and/or the structure(s) 124 using natural language (e.g., the monkey bars do not look safe). The user feedback data 158 can also identify specific instances in which the safety and/or accessibility of the area(s) of interest 122 and/or the structure(s) 124 are tested. For example, if the user 126 is hurt or observes an individual getting hurt while using the monkey bars, the user feedback data 158 can include an incident report. Incident reports collected over time can be included as part of the historical injury data 164.

The area data 160 can include any information specifically about the area(s) of interest 122. For example, if the area of interest 122 is a bridge, the area data 160 can identify when the bridge was built, an inspection history of the bridge, the materials used to build the bridge, specifications of the bridge (e.g., weight capacity), any safety features of the bridge (e.g., railings), and the like. The area data 160 can be obtained from land records, construction records, other government records, observations made by users (e.g., the user 126), a combination thereof, and/or the like. Other sources for the area data 160 are contemplated.

The structure data 162 can include any information specifically about the structure(s) 122. For example, if the structure 124 is a set of monkey bars, the structure data 162 can identify when the set of monkey bars was manufactured, the manufacturer, specifications for the monkey bars (e.g., weight capacity), any recalls for the monkey bars, safety precautions specified for the monkey bars, inspection records, combinations thereof, and/or the like. Other sources for the structure data 162 are contemplated.

The historical injury data 164 can include any information about injuries that occurred within the physical environment 120. The injuries may specifically involve the area(s) of interest 122 and/or the structure(s) 124. The injuries may be reported by users, such as the user 126, as part of the user feedback data 158. The injuries may be reported by police, fire, and/or emergency services. Other sources for the historical injury data 164 are contemplated.

The performance of the machine learning models 146 in providing accurate and consistent safety rating(s) 128 and/or accessibility rating(s) 130 can be evaluated using evaluation data sets, such as evaluation data sets 1010 discussed below with reference to FIG. 10, which include the same factors as those of the training and testing data sets 156 in order to ensure that the performance of the machine learning models 146 is adequate. The machine learning system 1000 can be implemented as part of the server computer 106 or separate from the server computer 106. For example, the machine learning system 1000 can train and test the machine learning models 146, and the server computer 106 can execute the machine learning models 146.

The safety and accessibility assistant service 108 can also include an extended reality module 166. The server computer 106 can execute the extended reality module 166 to create extended reality display data 168. The extended reality display data 168 can include the augmented reality object(s) 132 and/or the virtual reality object(s) 134, which can include the safety rating(s) 128 and/or the accessibility rating(s) 130. In some embodiments, additional augmented reality object(s) 132 and/or virtual reality object(s) 134 can be created separate from or in association with the safety rating(s) 128 and/or the accessibility rating(s) 130. The safety and accessibility assistant service 108 can provide the extended reality display data 168 to the user device 102 in response to the request 142. The user device 102, in turn, can present the extended reality display data 168 to the user 126 via the display 116 and/or the virtual reality device 139.

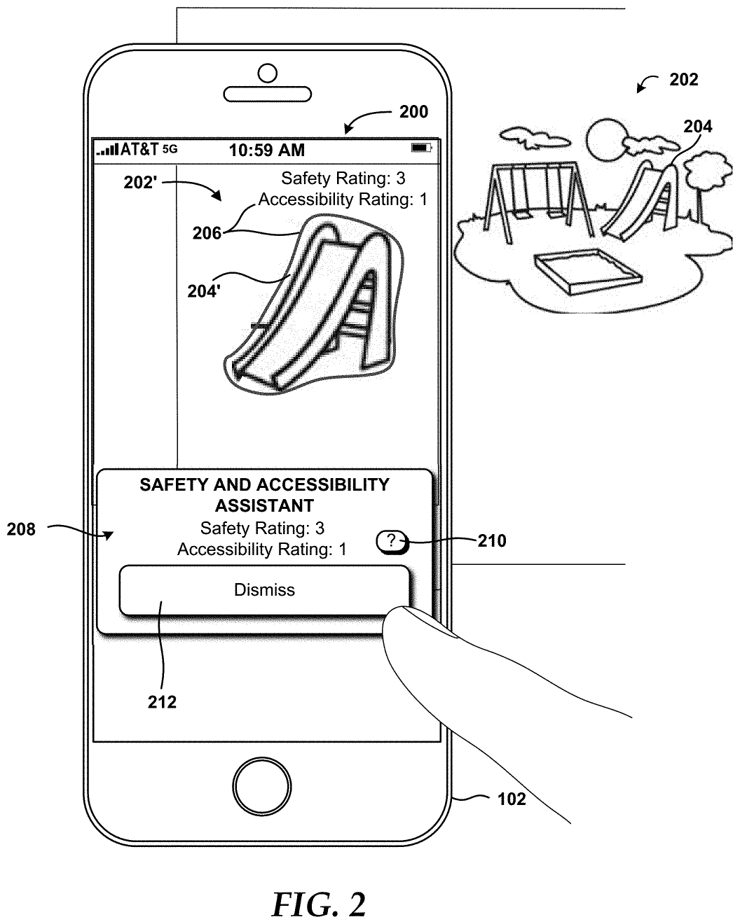

Turning now to FIG. 2, aspects of a user interface for providing and interacting with functionality associated with the safety and accessibility application 110 and the safety and accessibility assistant service 108 will be described, according to an illustrative embodiment. FIG. 2 shows an illustrative screen display 200 generated by the user device 102. According to various embodiments, the user device 102 can generate the screen display 200 and/or other screen displays in conjunction with execution of the safety and accessibility application 110 and based on the extended reality display data 168 received from the safety and accessibility assistant service 108. In some embodiments, the user device 102 can perform the functionality of the safety and accessibility assistant service 108 locally without the need to communicate with the server computer 106 via the network 104. It should be appreciated that the user interface illustrated in FIG. 2 is illustrative of one contemplated example of a user interface, and therefore should not be construed as being limited in any way.

The screen display 200 can include an image 202′ (e.g., the image 118) of a real-world environment 202 (e.g., the physical environment 120) captured by the acquisition device 114. In some embodiments, the real-world environment 202 can include an object 204. For example, as illustrated in FIG. 2, the object 204 can be a slide as part of a playground. The image 202′ on the screen display 200 can include a corresponding image 204′ of the object 204. The image 204′ of the object 204 can be captured in real-time by the acquisition device 114, according to some embodiments. The screen display 200 can also include augmented reality objects 206 (e.g., the augmented reality object(s) 132) received in the extended reality display data 168 from the safety and accessibility assistant service 108. In the illustrated example, the augmented reality objects 206 include a highlight around the image 204′ of the object 204 (i.e., the slide) and a corresponding safety rating 128 and/or accessibility rating 130. The augmented reality objects 206 can overlay the image 204′ of the object 204 from the real-world environment 202 on the screen display 200. As illustrated in FIG. 2, the augmented reality objects 206 can include a color or embellishment that acts as a highlight around the image 204′ of the object 204, which is being captured in real-time by the acquisition device 114, to indicate to the user 126 that the illustrated safety rating 128 and accessibility rating 130 are associated with the object 204. Although the augmented reality objects 206 in FIG. 2 are illustrated as a highlight around the image 204′ and text corresponding to the safety rating 128 and accessibility rating 130, one skilled in the art will understand and appreciate that the augmented reality objects 206 can take other forms such as text, images, texture, patterns, gradients, graphics, videos, animation, combinations thereof, and like, and can be overlaid in other positions in relation to the image 204′ of the object 204. Thus, the example of the augmented reality objects 206 illustrated in FIG. 2 should not be limiting in any way.

The screen display 200 can also include a safety and accessibility assistant window 208. The safety and accessibility assistant window 208 can include an alert of the extended reality display data 168. The safety and accessibility assistant window 208 can overlay the image 202′ of the real-world environment 202 on the screen display 200. The safety and accessibility assistant window 208 can also present a user interface control 210 associated with the safety rating 128 and/or the accessibility rating 130. If the user 126 selects the user interface control 210, another window (not shown) can open and can provide a description of how the safety rating 128 and/or the accessibility rating 130 was determined. For instance, the description may explain that a safety rating of 3 out of 5 was assigned to the object 204 because the object 204 does not have data indicative of a recent safety/maintenance check. Additionally or alternatively, the safety rating 128 and/or the accessibility rating 130 may be based on the training data of one or more of the training and testing data sets 156. It should be understood that this example is illustrative and therefore should not be construed as being limiting in any way. The accessibility assistant window 208 can be closed via a dismiss button 212.

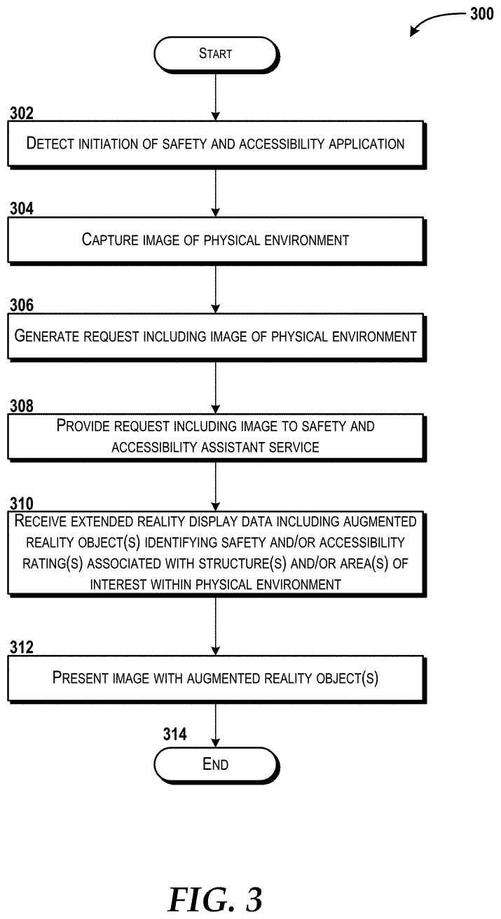

Turning now to FIG. 3, aspects of a method 300 for requesting and presenting the extended reality display data 168 for an existing physical environment 120 will be described, according to an illustrative embodiment of the concepts and technologies described herein. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, such as the user device 102 and/or the server computer 106, to perform one or more operations and/or causing the processor to direct other components of the computing system or device to perform one or more of the operations.

For purposes of illustrating and describing the concepts of the present disclosure, the methods disclosed herein are described as being performed by the user device 102 via execution of one or more software modules such as, for example, the safety and accessibility application 110 and/or the blueprinting application 112, or the server computer 106 via execution of one or more software modules such as, for example, the safety and accessibility module 144 and/or the extended reality module 166. It should be understood that additional and/or alternative devices and/or network nodes can provide the functionality described herein via execution of one or more modules, applications, and/or other software including, but not limited to, the safety and accessibility application 110, the blueprinting application 112, the safety and accessibility module 144, and/or the extended reality module 166. Thus, the illustrated embodiments are illustrative, and should not be viewed as being limiting in any way.

The method 300 is described in context of the physical environment 120 being an existing physical environment 120. In other words, the physical environment 120 has been designed, the area(s) of interest 122 have been created/developed, and the structure(s) 124 have been placed/installed.

The method 300 begins and proceeds to operation 302. At operation 302, the user device 102 can detect initiation of the safety and accessibility application 110. For example, the user 126 can interact with an icon associated with the safety and accessibility application 110 to launch the safety and accessibility application 110. Alternatively, the safety and accessibility application 110 can launch automatically based upon a location of the user device 102 (e.g., within a geo-fence associated with the physical environment 120).

From operation 302, the method 300 proceeds to operation 304. At operation 304, the user device 102 can capture, via the acquisition device 114, one or more images 118 of the physical environment 120. As noted above, the image(s) 118 can be live images (e.g., live video or photograph) or non-live images (e.g., recorded video or photograph) that can be presented on the display 116. The image(s) 118 as live image(s) can be presented on the display 116 in real-time as the acquisition device 114 captures a live view of the physical environment 120.

From operation 304, the method 300 proceeds to operation 306. At operation 306, the user device 102 can generate a request 142 including the image 118 of the physical environment 120. From operation 306, the method 300 proceeds to operation 308. At operation 308, the user device 102 provides the request 142 to the safety and accessibility assistant service 108.

From operation 308, the method 300 proceeds to operation 310. At operation 310, the user device 102 receives the extended reality display data 168 from the safety and accessibility assistant service 108. The extended reality display data 168 can include one or more augmented reality objects 132 identifying the safety rating(s) 128 and/or the accessibility rating(s) 130 associated with the area(s) of interest 122 and/or the structure(s) 124 within the physical environment 120. The augmented reality objects 132 can also include highlights and/or other embellishments around the area(s) of interest 122 and/or the structure(s) 124 for which the extended reality display data 168 includes the safety rating(s) 128 and/or the accessibility rating(s) 130. An example of this is shown in FIG. 2.

From operation 310, the method 300 proceeds to operation 312. At operation 312, the user device 102 presents the image 118 with the augmented reality object(s) 132. As noted above, the augmented reality object(s) 132 can be presented as an overlay of and/or spatially integrated with real-world objects, such as the area(s) of interest 122 and/or the structure(s) 124 of the physical environment 120, on the display 116.

From operation 312, the method 300 proceeds to operation 314. The method 300 can end at operation 314.

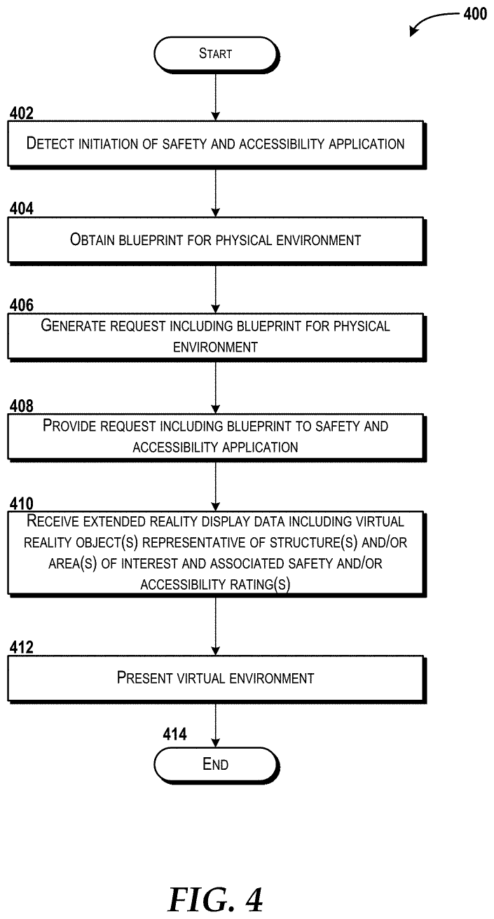

Turning now to FIG. 4, aspects of a method 400 requesting and presenting the extended reality display data 168 for a future physical environment 120 will be described, according to an illustrative embodiment of the concepts and technologies disclosed herein. The method 400 is described in context of the physical environment 120 being a future physical environment 120. In other words, the physical environment 120 has not been designed, the area(s) of interest 122 have not been created/developed, and the structure(s) 124 have not been placed/installed.

The method 400 begins and proceeds to operation 402. At operation 402, the user device 102 can detect initiation of the safety and accessibility application 110. For example, the user 126 can interact with an icon associated with the safety and accessibility application 110 to launch the safety and accessibility application 110. Alternatively, the safety and accessibility application 110 can launch automatically based upon a location of the user device 102 (e.g., within a geo-fence associated with the physical environment 120).

From operation 402, the method 400 proceeds to operation 404. At operation 404, the user device 102 can obtain a blueprint 140 for the physical environment 120. In some embodiments, the blueprint 140 is at least partially pre-defined and the user device 102 can download the blueprint 140 (or a template thereof) from a marketplace or website. In some embodiments, the user device 102 can execute the blueprinting application 112 through which the user 126 can define the blueprint 140.

From operation 404, the method 400 proceeds to operation 406. At operation 406, the user device 102 can generate a request 142 including the blueprint 140 of the physical environment 102. From operation 406, the method 400 proceeds to operation 408. At operation 408, the user device 102 provides the request 142 to the safety and accessibility assistant service 108.

From operation 408, the method 400 proceeds to operation 410. At operation 410, the user device 102 can receive the extended reality display data 168 from the safety and accessibility assistant service 108. The extended reality display data 168 can include one or more virtual reality objects 134 identifying the safety rating(s) 128 and/or the accessibility rating(s) 130 associated with the area(s) of interest 122 and/or the structure(s) 124 within the physical environment 120. The virtual reality objects 134 can also include virtual representations of the area(s) of interest 122 and/or the structure(s) 124 of the virtual environment 136 in accordance with the blueprint 140.

From operation 410, the method 400 proceeds to operation 412. At operation 412, the user device 102 can present the virtual environment 136 that contains the virtual reality object(s) 134 such as computer-generated representations of the physical environment 120, the area(s) of interest 122, and/or the structure(s) 124 and the safety rating(s) 128 and/or accessibility rating(s) 130 associated therewith. In some embodiments, the user device 102 can present the virtual environment 136 via the virtual reality device 139.

From operation 412, the method 400 proceeds to operation 414. The method 400 can end at operation 414.

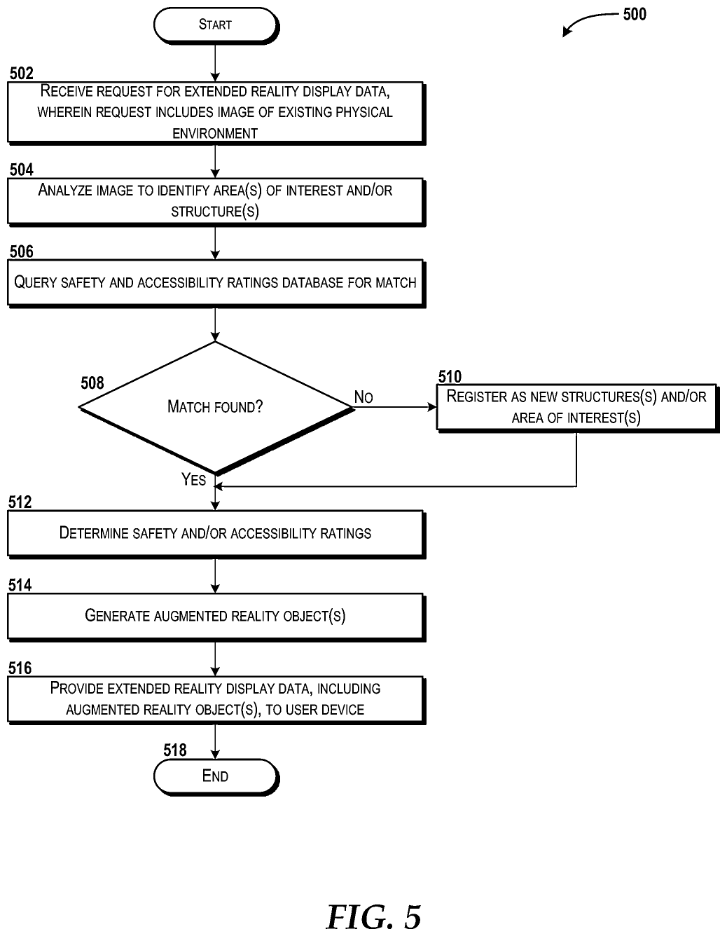

Turning now to FIG. 5, aspects of a method 500 for generating and providing the extended reality display data 168 for the existing physical environment 120 will be described, according to an illustrative embodiment of the concepts and technologies described herein. The method 500 is described in context of the physical environment 120 being an existing physical environment 120. In other words, the physical environment 120 has been designed, the area(s) of interest 122 have been created/developed, and the structure(s) 124 have been placed/installed.

The method 500 begins and proceeds to operation 502. At operation 502, the server computer 106 can receive the request 142. The request 142 can include one or more images 118 of the physical environment 120. As noted above, the image(s) 118 can be live images (e.g., live video or photograph) or non-live images (e.g., recorded video or photograph) that can be presented on the display 116. The image(s) 118 as live image(s) can be presented on the display 116 in real-time as the acquisition device 114 captures a live view of the physical environment 120.

From operation 502, the method 500 proceeds to operation 504. At operation 504, the server computer 106, via execution of the safety and accessibility module 144, can analyze the image(s) 118 to identify the area(s) of interest 122 and/or the structure(s) 124. From operation 504, the method 500 proceeds to operation 506. At operation 506, the server computer 106 can query the safety and accessibility ratings database 152 for a safety rating 128 and/or an accessibility rating 130 associated with each of the area(s) of interest 122 and/or the structure(s) 124 identified in the image(s) 118. From operation 506, the method 500 proceeds to operation 508. At operation 508, the server computer 106 determines if a match is found. If a match is not found, the method 500 proceeds to operation 510. At operation 510, the server computer 106 can register the area(s) of interest 122 and/or the structure(s) 124 identified in the image(s) 118 as new area(s) of interest 122 and/or structure(s) 124.

From operation 510, the method 500 proceeds to operation 512. At operation 512, the server computer 106 can determine the safety rating(s) 128 and/or the accessibility rating(s) 130 for the new area(s) of interest(s) 122 and/or the new structure(s) 124. For example, the safety and accessibility module 144 can use the machine learning models 146 to determine the safety rating(s) 128 and/or the accessibility rating(s) 130. In some embodiments, the machine learning models 146 can be trained based upon one or more of the training and testing data sets 156 including the user feedback data 158, the area data 160, the structure data 162, the historical injury data 164, a combination thereof, and/or the like. Returning to operation 508, if a match is found, the method 500 proceeds directly to operation 512, where the server computer 106 can determine the safety rating(s) 128 and/or the accessibility rating(s) 130 for the area(s) of interest(s) 122 and/or the structure(s) 124 identified in the image(s) 118.

From operation 512, the method 500 proceeds to operation 514. At operation 514, the server computer 106, via execution of the extended reality module 166, can generate the extended reality display data 168 including one or more augmented reality objects 132 identifying the safety rating(s) 128 and/or the accessibility rating(s) 130 associated with the area(s) of interest 122 and/or the structure(s) 124 within the physical environment 120. The augmented reality objects 132 can also include highlights and/or other embellishments around the area(s) of interest 122 and/or the structure(s) 124 for which the extended reality display data 168 includes the safety rating(s) 128 and/or the accessibility rating(s) 130.

From operation 514, the method 500 proceeds to operation 516. At operation 516, the sever computer 106 can provide the extended reality display data 168 to the user device 102 for presentation to the user 126.

From operation 516, the method 500 proceeds to operation 518. The method 500 can end at operation 518.

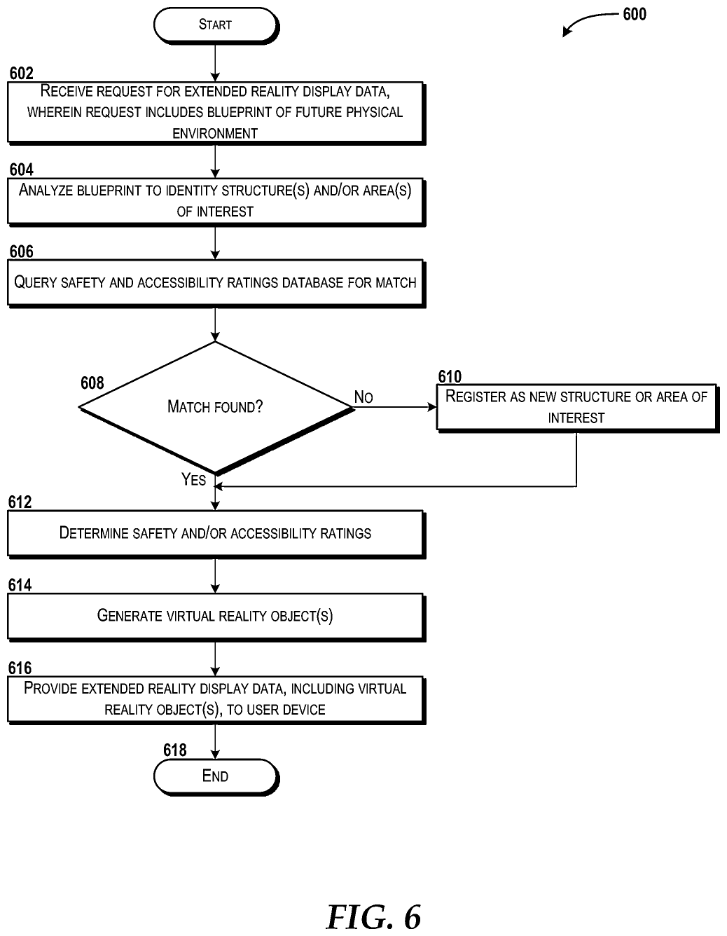

Turning now to FIG. 6, aspects of a method 600 for generating and providing the extended reality display data 168 for the future physical environment 120 will be described, according to an illustrative embodiment of the concepts and technologies described herein. The method 600 is described in context of the physical environment 120 being a future physical environment 120. In other words, the physical environment 120 has not been designed, the area(s) of interest 122 have not been created/developed, and the structure(s) 124 have not been placed/installed.

The method 600 begins and proceeds to operation 602. At operation 602, the server computer 106 can receive the request 142. The request 142 can include one or more blueprints 140 of the physical environment 120. From operation 602, the method 600 proceeds to operation 604. At operation 604, the server computer 106, via execution of the safety and accessibility module 144, can analyze the blueprint(s) 140 to identify the area(s) of interest 122 and/or the structure(s) 124. From operation 604, the method 600 proceeds to operation 606. At operation 606, the server computer 106 can query the safety and accessibility ratings database 152 for a safety rating 128 and/or an accessibility rating 130 associated with each of the area(s) of interest 122 and/or the structure(s) 124 identified in the blueprint(s) 140. From operation 606, the method 600 proceeds to operation 608. At operation 608, the server computer 106 determines if a match is found. If a match is not found, the method 600 proceeds to operation 610. At operation 610, the server computer 106 can register the area(s) of interest 122 and/or the structure(s) 124 identified in the blueprint(s) 140 as new area(s) of interest 122 and/or structure(s) 124.

From operation 610, the method 600 proceeds to operation 612. At operation 612, the server computer 106 can determine the safety rating(s) 128 and/or the accessibility rating(s) 130 for the new area(s) of interest(s) 122 and/or the new structure(s) 124. For example, the safety and accessibility module 144 can use the machine learning models 146 to determine the safety rating(s) 128 and/or the accessibility rating(s) 130. In some embodiments, the machine learning models 146 can be trained based upon one or more of the training and testing data sets 156 including the user feedback data 158, the area data 160, the structure data 162, the historical injury data 164, a combination thereof, and/or the like. Returning to operation 608, if a match is found, the method 600 proceeds directly to operation 612, where the server computer 106 can determine the safety rating(s) 128 and/or the accessibility rating(s) 130 for the area(s) of interest(s) 122 and/or the structure(s) 124 identified in the blueprint(s) 118.

From operation 612, the method 600 proceeds to operation 614. At operation 614, the server computer 106, via execution of the extended reality module 166, can generate the extended reality display data 168 including one or more virtual reality objects 134 identifying the safety rating(s) 128 and/or the accessibility rating(s) 130 associated with the area(s) of interest 122 and/or the structure(s) 124 within the physical environment 120. The virtual reality objects 134 can also include virtual representations of the area(s) of interest 122 and/or the structure(s) 124 of the virtual environment 136 in accordance with the blueprint 140.

From operation 614, the method 600 proceeds to operation 616. At operation 616, the sever computer 106 can provide the extended reality display data 168 to the user device 102 for presentation to the user 126.

From operation 616, the method 600 proceeds to operation 618. The method 600 can end at operation 618.

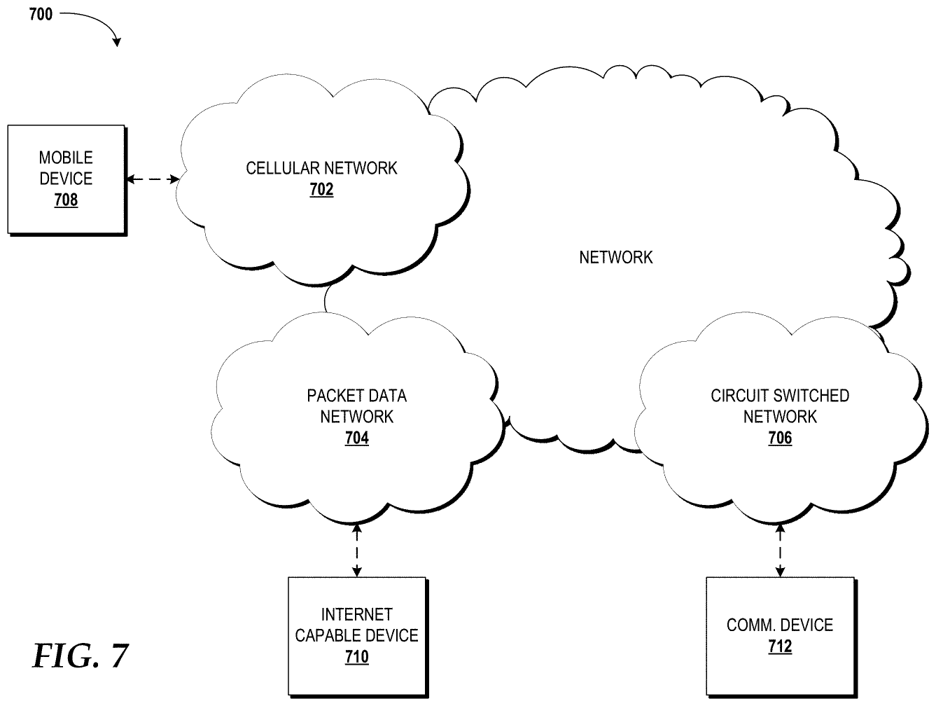

Turning now to FIG. 7, details of a network 700 are illustrated, according to an illustrative embodiment. In some embodiments, the network 104 shown in FIG. 1 can be configured the same as or similar to the network 700. The network 700 includes a cellular network 702, a packet data network 704, and a circuit switched network 706 (e.g., a public switched telephone network). The cellular network 702 includes various components such as, but not limited to, base transceiver stations (“BTSs”), Node-Bs or e-Node-Bs, base station controllers (“BSCs”), radio network controllers (“RNCs”), mobile switching centers (“MSCs”), mobility management entities (“MMEs”), short message service centers (“SMSCs”), multimedia messaging service centers (“MMSCs”), home location registers (“HLRs”), home subscriber servers (“HSSs”), visitor location registers (“VLRs”), charging platforms, billing platforms, voicemail platforms, GPRS core network components, location service nodes, and the like. The cellular network 702 also includes radios and nodes for receiving and transmitting voice, data, and combinations thereof to and from radio transceivers, networks, the packet data network 704, and the circuit switched network 706.

A mobile communications device 708, such as, for example, the user device 102, a mobile device 900 (shown in FIG. 9), a cellular telephone, a user equipment, a mobile terminal, a PDA, a laptop computer, a handheld computer, and combinations thereof, can be operatively connected to the cellular network 702. The cellular network 702 can be configured as a Global System for Mobile communications (“GSM”) network and can provide data communications via General Packet Radio Service (“GPRS”) and/or Enhanced Data rates for Global Evolution (“EDGE”). Additionally, or alternatively, the cellular network 702 can be configured as a 3G Universal Mobile Telecommunications System (“UMTS”) network and can provide data communications via the High-Speed Packet Access (“HSPA”) protocol family, for example, High-Speed Downlink Packet Access (“HSDPA”), High-Speed Uplink Packet Access (“HSUPA”) (also known as Enhanced Uplink “EUL”), and HSPA+. The cellular network 702 also is compatible with mobile communications standards such as Long-Term Evolution (“LTE”), or the like, as well as evolved and future mobile standards.

The packet data network 704 includes various systems, devices, servers, computers, databases, and other devices in communication with one another, as is generally known. The user device 102, the server computer 106, the datastore 150, or some combination thereof can communicate with each other via the packet data network 704. In some embodiments, the packet data network 704 is or includes one or more WI-FI networks, each of which can include one or more WI-FI access points, routers, switches, and other WI-FI network components. The packet data network 704 devices are accessible via one or more network links. The servers often store various files that are provided to a requesting device such as, for example, a computer, a terminal, a smartphone, or the like. Typically, the requesting device includes software for executing a web page in a format readable by the browser or other software. Other files and/or data may be accessible via “links” in the retrieved files, as is generally known. In some embodiments, the packet data network 704 includes or is in communication with the Internet. The circuit switched network 706 includes various hardware and software for providing circuit switched communications. The circuit switched network 706 may include, or may be, what is often referred to as a plain old telephone system (“POTS”). The functionality of a circuit switched network 706 or other circuit-switched network are generally known and will not be described herein in detail.

The illustrated cellular network 702 is shown in communication with the packet data network 704 and a circuit switched network 706, though it should be appreciated that this is not necessarily the case. One or more Internet-capable systems/devices 710 such as the user device(s) 102, the server computer 106, the datastore 150, a laptop, a portable device, or another suitable device, can communicate with one or more cellular networks 702, and devices connected thereto, through the packet data network 704. It also should be appreciated that the Internet-capable device 710 can communicate with the packet data network 704 through the circuit switched network 706, the cellular network 702, and/or via other networks (not illustrated).

As illustrated, a communications device 712, for example, a telephone, facsimile machine, modem, computer, or the like, can be in communication with the circuit switched network 706, and therethrough to the packet data network 704 and/or the cellular network 702. It should be appreciated that the communications device 712 can be an Internet-capable device, and can be substantially similar to the Internet-capable device 710.

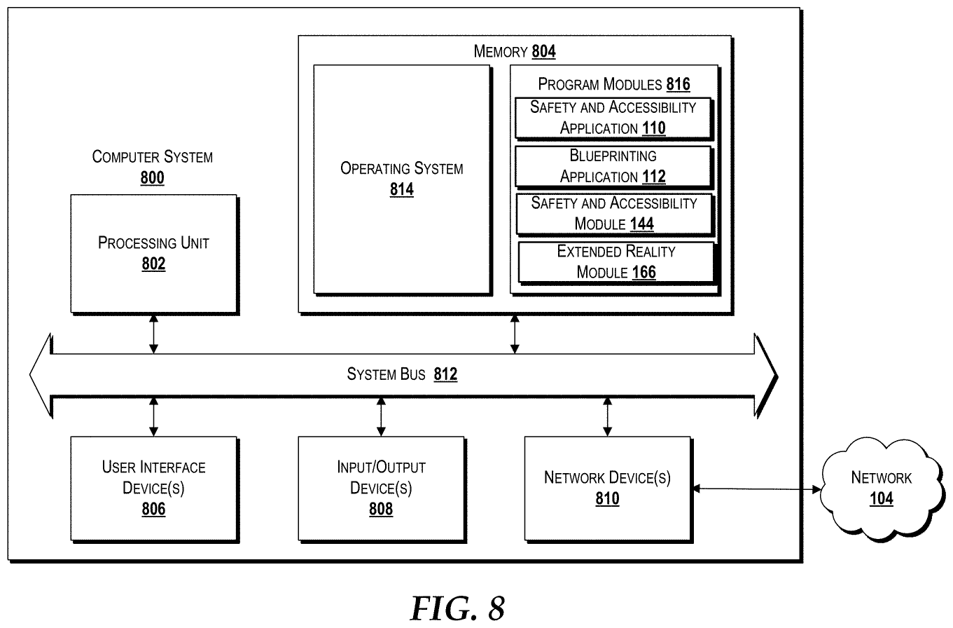

Turning now to FIG. 8, a block diagram illustrating a computer system 800 configured to provide the functionality in accordance with various embodiments of the concepts and technologies disclosed herein. The systems, devices, and other components disclosed herein can utilize, at least in part, an architecture that is the same as or at least similar to the architecture of the computer system 800. In some embodiments, one or more of the user device 102, the server computer 106, and/or the datastore 150 can be configured like the computer system 800. It should be understood, however, that modification to the architecture may be made to facilitate certain interactions among elements described herein.

The computer system 800 includes a processing unit 802, a memory 804, one or more user interface devices 806, one or more input/output (“I/O”) devices 808, and one or more network devices 810, each of which is operatively connected to a system bus 812. The system bus 812 enables bi-directional communication between the processing unit 802, the memory 804, the user interface devices 806, the I/O devices 808, and the network devices 810.

The processing unit 802 may be a standard central processor that performs arithmetic and logical operations, a more specific purpose programmable logic controller (“PLC”), a programmable gate array, or other type of processor known to those skilled in the art and suitable for controlling the operation of the server computer. Processing units are generally known, and therefore are not described in further detail herein.

The memory 804 communicates with the processing unit 802 via the system bus 812. In some embodiments, the memory 804 is operatively connected to a memory controller (not shown) that enables communication with the processing unit 802 via the system bus 812. The illustrated memory 804 includes an operating system 814 and one or more program modules 816. The operating system 814 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, OS X, and/or iOS families of operating systems from APPLE CORPORATION, the FREEBSD family of operating systems, the SOLARIS family of operating systems from ORACLE CORPORATION, other operating systems, and the like.

The program modules 816 may include various software and/or program modules to perform the various operations described herein. In some embodiments, for example, the program modules 816 can include the safety and accessibility application 110, the blueprinting application 112, the safety and accessibility module 144, the extended reality module 166, and/or other program modules. These and/or other programs can be embodied in computer-readable media containing instructions that, when executed by the processing unit 802, in some embodiments, may perform and/or facilitate performance of one or more of the method 300 described in detail above with respect to FIG. 3, the method 400 described in detail above with respect to FIG. 4, the method 500 described in detail above with respect to FIG. 5, and the method 600 described in detail above with respect to FIG. 6. According to some embodiments, the program modules 816 may be embodied in hardware, software, firmware, or any combination thereof. Although not shown in FIG. 8, it should be understood that the memory 804 also can be configured to store the image(s) 118, the safety rating(s) 128, the accessibility ratings 130, the blueprint(s) 140, the augmented reality object(s) 132, the virtual reality object(s) 134, the training and testing data sets 156, and/or other data, if desired.

By way of example, and not limitation, computer-readable media may include any available computer storage media or communication media that can be accessed by the computer system 800. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 800. In the claims, the phrase “computer storage medium,” “computer-readable storage medium,” and variations thereof does not include waves or signals per se and/or communication media, and therefore should be construed as being directed to “non-transitory” media only.

The user interface devices 806 may include one or more devices with which a user accesses the computer system 800. The user interface devices 806 may include, but are not limited to, computers, servers, PDAs, cellular phones, or any suitable computing devices. The I/O devices 808 enable a user to interface with the program modules 816. In one embodiment, the I/O devices 808 are operatively connected to an I/O controller (not shown) that enables communication with the processing unit 802 via the system bus 812. The I/O devices 808 may include one or more input devices, such as, but not limited to, a keyboard, a mouse, or an electronic stylus. Further, the I/O devices 808 may include one or more output devices, such as, but not limited to, a display screen or a printer. In some embodiments, the I/O devices 808 can be used for manual controls for operations to exercise under certain emergency situations.

The network devices 810 enable the computer system 800 to communicate with other networks or remote systems via a network 818, such as the network 104. Examples of the network devices 810 include, but are not limited to, a modem, a radio frequency (“RF”) or infrared (“IR”) transceiver, a telephonic interface, a bridge, a router, or a network card. The network 818 may be or may include a wireless network such as, but not limited to, a Wireless Local Area Network (“WLAN”), a Wireless Wide Area Network (“WWAN”), a Wireless Personal Area Network (“WPAN”) such as provided via BLUETOOTH technology, a Wireless Metropolitan Area Network (“WMAN”) such as a WiMAX network or metropolitan cellular network. Alternatively, the network 818 may be or may include a wired network such as, but not limited to, a Wide Area Network (“WAN”), a wired Personal Area Network (“PAN”), a wired Metropolitan Area Network (“MAN”), a VoIP network, an IP/MPLS network, a PSTN network, an IMS network, an EPC network, or any other mobile network and/or wireline network.

Turning now to FIG. 9, an illustrative mobile device 900 and components thereof will be described. In some embodiments, the user device 102 (shown in FIG. 1) can be configured like the mobile device 900. While connections are not shown between the various components illustrated in FIG. 9, it should be understood that some, none, or all of the components illustrated in FIG. 9 can be configured to interact with one other to carry out various device functions. In some embodiments, the components are arranged so as to communicate via one or more busses (not shown). Thus, it should be understood that FIG. 9 and the following description are intended to provide a general understanding of a suitable environment in which various aspects of embodiments can be implemented, and should not be construed as being limiting in any way.

As illustrated in FIG. 9, the mobile device 900 can include a display 902 for displaying data. In some embodiments, the display 116 can be configured like the display 902. According to various embodiments, the display 902 can be configured to display various graphical user interface (“GUI”) elements, text, images, video, virtual keypads and/or keyboards, messaging data, notification messages, metadata, internet content, device status, time, date, calendar data, device preferences, map and location data, combinations thereof, and/or the like. The mobile device 900 also can include a processor 904 and a memory or other data storage device (“memory”) 906. The processor 904 can be configured to process data and/or can execute computer-executable instructions stored in the memory 906. The computer-executable instructions executed by the processor 904 can include, for example, an operating system 908 (e.g., the device operating system 109), one or more applications 910 (e.g., the safety and accessibility application 110 and the blueprinting application 112), other computer-executable instructions stored in a memory 906, or the like. In some embodiments, the applications 910 also can include a user interface (“UP”) application (not illustrated in FIG. 9).

The UI application can interface with the operating system 908 to facilitate user interaction with functionality and/or data stored at the mobile device 900 and/or stored elsewhere. In some embodiments, the operating system 908 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 904 to aid a user in entering content, launching the safety and accessibility application 110 and the blueprinting application 112, capturing the image(s) 118 via the acquisition device 114, viewing the extended reality display data 168, designing the blueprint(s) 140, entering/deleting data, entering and setting local credentials (e.g., user IDs and passwords) for device access, configuring settings, manipulating address book content and/or settings, multimode interaction, interacting with other applications 910, and otherwise facilitating user interaction with the operating system 908, the applications 910, and/or other types or instances of data 912 that can be stored at the mobile device 900. The data 912 can include, for example, one or more identifiers, and/or other applications or program modules. According to various embodiments, the applications 910 can include, for example, presence applications, visual voice mail applications, messaging applications, text-to-speech and speech-to-text applications, add-ons, plug-ins, email applications, music applications, video applications, camera applications, location-based service applications, power conservation applications, game applications, productivity applications, entertainment applications, enterprise applications, combinations thereof, and the like. The applications 910, the data 912, and/or portions thereof can be stored in the memory 906 and/or in a firmware 914, and can be executed by the processor 904. The firmware 914 also can store code for execution during device power up and power down operations. It can be appreciated that the firmware 914 can be stored in a volatile or non-volatile data storage device including, but not limited to, the memory 906 and/or a portion thereof.

The mobile device 900 also can include an input/output (“I/O”) interface 916. The I/O interface 916 can be configured to support the input/output of data such as location information, user information, organization information, presence status information, user IDs, passwords, and application initiation (start-up) requests. In some embodiments, the I/O interface 916 can include a hardwire connection such as USB port, a mini-USB port, a micro-USB port, an audio jack, a PS2 port, an IEEE 1394 (“FIREWIRE”) port, a serial port, a parallel port, an Ethernet (RJ45) port, an RJ10 port, a proprietary port, combinations thereof, or the like. In some embodiments, the mobile device 900 can be configured to synchronize with another device to transfer content to and/or from the mobile device 900. In some embodiments, the mobile device 900 can be configured to receive updates to one or more of the applications 910 via the I/O interface 916, though this is not necessarily the case. In some embodiments, the I/O interface 916 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 916 may be used for communications between the mobile device 900 and a network device or local device.

The mobile device 900 also can include a communications component 918. The communications component 918 can be configured to interface with the processor 904 to facilitate wired and/or wireless communications with one or more networks such as one or more IP access networks and/or one or more circuit access networks. In some embodiments, other networks include networks that utilize non-cellular wireless technologies such as WI-FI or WIMAX. In some embodiments, the communications component 918 includes a multimode communications subsystem for facilitating communications via the cellular network and one or more other networks.

The communications component 918, in some embodiments, includes one or more transceivers. The one or more transceivers, if included, can be configured to communicate over the same and/or different wireless technology standards with respect to one another. For example, in some embodiments one or more of the transceivers of the communications component 918 may be configured to communicate using Global System for Mobile communications (“GSM”), Code Division Multiple Access (“CDMA”) ONE, CDMA2000, Long-Term Evolution (“LTE”), and various other 2G, 2.5G, 3G, 4G, 5G, and greater generation technology standards. Moreover, the communications component 918 may facilitate communications over various channel access methods (which may or may not be used by the aforementioned standards) including, but not limited to, Time-Division Multiple Access (“TDMA”), Frequency-Division Multiple Access (“FDMA”), Wideband CDMA (“W-CDMA”), Orthogonal Frequency-Division Multiplexing (“OFDM”), Space-Division Multiple Access (“SDMA”), and the like.

In addition, the communications component 918 may facilitate data communications using Generic Packet Radio Service (“GPRS”), Enhanced Data Rates for Global Evolution (“EDGE”), the High-Speed Packet Access (“HSPA”) protocol family including High-Speed Download Packet Access (“HSDPA”), Enhanced Uplink (“EUL”) or otherwise termed High-Speed Upload Packet Access (“HSUPA”), HSPA+, and various other current and future wireless data access standards. In the illustrated embodiment, the communications component 918 can include a first transceiver (“TxRx”) 920A that can operate in a first communications mode (e.g., GSM). The communications component 918 also can include an N^{th} transceiver (“TxRx”) 920N that can operate in a second communications mode relative to the first transceiver 920A (e.g., UMTS). While two transceivers 920A-920N (hereinafter collectively and/or generically referred to as “transceivers 920”) are shown in FIG. 9, it should be appreciated that less than two, two, and/or more than two transceivers 920 can be included in the communications component 918.

The communications component 918 also can include an alternative transceiver (“Alt TxRx”) 922 for supporting other types and/or standards of communications. According to various contemplated embodiments, the alternative transceiver 922 can communicate using various communications technologies such as, for example, WI-FI, WIMAX, BLUETOOTH, infrared, infrared data association (“IRDA”), near-field communications (“NFC”), ZIGBEE, other radio frequency (“RF”) technologies, combinations thereof, and the like.

In some embodiments, the communications component 918 also can facilitate reception from terrestrial radio networks, digital satellite radio networks, internet-based radio service networks, combinations thereof, and the like. The communications component 918 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 900 also can include one or more sensors 924. The sensors 924 can include temperature sensors, light sensors, air quality sensors, movement sensors, orientation sensors, noise sensors, proximity sensors, or the like. As such, it should be understood that the sensors 924 can include, but are not limited to, accelerometers, magnetometers, gyroscopes, infrared sensors, noise sensors, microphones, combinations thereof, or the like. Additionally, audio capabilities for the mobile device 900 may be provided by an audio I/O component 926. The audio I/O component 926 of the mobile device 900 can include one or more speakers for the output of audio signals, one or more microphones for the collection and/or input of audio signals, and/or other audio input and/or output devices.

The illustrated mobile device 900 also can include a subscriber identity module (“SIM”) system 928. The SIM system 928 can include a universal SIM (“USIM”), a universal integrated circuit card (“UICC”) and/or other identity devices. The SIM system 928 can include and/or can be connected to or inserted into an interface such as a slot interface 930. In some embodiments, the slot interface 930 can be configured to accept insertion of other identity cards or modules for accessing various types of networks. Additionally, or alternatively, the slot interface 930 can be configured to accept multiple subscriber identity cards. Because other devices and/or modules for identifying users and/or the mobile device 900 are contemplated, it should be understood that these embodiments are illustrative, and should not be construed as being limiting in any way.

The mobile device 900 also can include an image capture and processing system 932 (“image system”). The image system 932 can be configured to capture or otherwise obtain photos, videos, and/or other visual information. As such, the image system 932 can include cameras, lenses, charge-coupled devices (“CCDs”), combinations thereof, or the like. The mobile device 900 may also include a video system 934. The video system 934 can be configured to capture, process, record, modify, and/or store video content. Photos and videos obtained using the image system 932 and the video system 934, respectively, may be added as message content to an MMS message, email message, and sent to another mobile device. The video and/or photo content also can be shared with other devices via various types of data transfers via wired and/or wireless communication devices as described herein. The acquisition device 114 can be configured like the image system 932 and/or the video system 934.

The mobile device 900 also can include one or more location components 936. The location components 936 can be configured to send and/or receive signals to determine a geographic location of the mobile device 900. According to various embodiments, the location components 936 can send and/or receive signals from global positioning system (“GPS”) devices, assisted GPS (“A-GPS”) devices, WI-FI/WIMAX and/or cellular network triangulation data, combinations thereof, and the like. The location component 936 also can be configured to communicate with the communications component 918 to retrieve triangulation data for determining a location of the mobile device 900. In some embodiments, the location component 936 can interface with cellular network nodes, telephone lines, satellites, location transmitters and/or beacons, wireless network transmitters and receivers, combinations thereof, and the like. In some embodiments, the location component 936 can include and/or can communicate with one or more of the sensors 924 such as a compass, an accelerometer, and/or a gyroscope to determine the orientation of the mobile device 900. Using the location component 936, the mobile device 900 can generate and/or receive data to identify its geographic location, or to transmit data used by other devices to determine the location of the mobile device 900. The location component 936 may include multiple components for determining the location and/or orientation of the mobile device 900.

The illustrated mobile device 900 also can include a power source 938. The power source 938 can include one or more batteries, power supplies, power cells, and/or other power subsystems including alternating current (“AC”) and/or direct current (“DC”) power devices. The power source 938 also can interface with an external power system or charging equipment via a power I/O component 940. Because the mobile device 900 can include additional and/or alternative components, the above embodiment should be understood as being illustrative of one possible operating environment for various embodiments of the concepts and technologies described herein. The described embodiment of the mobile device 900 is illustrative, and should not be construed as being limiting in any way.

Turning now to FIG. 10, the machine learning system 1000 capable of implementing aspects of the embodiments disclosed herein will be described. The machine learning system 1000 can be used to train the machine learning models 146. Accordingly, the server computer 106 can include the machine learning system 1000 or can be in communication with the machine learning system 1000.

The illustrated machine learning system 1000 includes one or more machine learning models 1002, such the machine learning models 146. The machine learning models 1002 can include, unsupervised, supervised, and/or semi-supervised learning models. The machine learning model(s) 1002 can be created by the machine learning system 1000 based upon one or more machine learning algorithms 1004. The machine learning algorithm(s) 1004 can be any existing, well-known algorithm, any proprietary algorithms, or any future machine learning algorithm. Some example machine learning algorithms 1004 include, but are not limited to, neural networks, gradient descent, linear regression, logistic regression, linear discriminant analysis, decision trees, Naive Bayes, K-nearest neighbor, learning vector quantization, support vector machines, principal component analysis, and the like. Neural networks and random forest classification and regression algorithms might find particular applicability to the concepts and technologies disclosed herein. Those skilled in the art will appreciate the applicability of various machine learning algorithms 1004 based upon the problem(s) to be solved by machine learning via the machine learning system 1000.

The machine learning system 1000 can control the creation of the machine learning models 1002 via one or more training parameters (also referred to as “tuning parameters”). In some embodiments, the training parameters are selected variables or factors at the direction of an enterprise, for example. Alternatively, in some embodiments, the training parameters are automatically selected based upon data provided in one or more training data sets 1006. The training parameters can include, for example, a learning rate where relevant such as when a classification algorithm is utilized, a model size, a number of training passes, data shuffling, regularization, and/or other training parameters known to those skilled in the art. The training data in the training data sets 1006 can include the user feedback data 158, the area data 160, the structure data 162, and the historical injury data 164.

The learning rate is a training parameter defined by a constant value. The learning rate affects the speed at which the machine learning algorithm 1004 converges to the optimal weights. The machine learning algorithm 1004 can update the weights for every data example included in the training data sets 1006. The size of an update is controlled by the learning rate. A learning rate that is too high might prevent the machine learning algorithm 1004 from converging to the optimal weights. A learning rate that is too low might result in the machine learning algorithm 1004 requiring multiple training passes to converge to the optimal weights.

The model size is regulated by the number of input features (“features”) 1008 in the training data sets 1006. The training data sets 1006 and evaluation data sets 1010 discussed further below may be selected based on an appropriate training/test split for training and evaluation, such as an 80/20 split.

The number of training passes indicates the number of training passes that the machine learning algorithm 1004 makes over the training data sets 1006 during the training process. The number of training passes can be adjusted based, for example, on the size of the training data sets 1006, with larger training data sets being exposed to fewer training passes in consideration of time and/or resource utilization. The performance of the resultant machine learning model 1002 can be increased by multiple training passes.

Data shuffling is a training parameter designed to prevent the machine learning algorithm 1004 from reaching false optimal weights due to the order in which data contained in the training data sets 1006 is processed. For example, data provided in rows and columns might be analyzed first row, second row, third row, etc., and thus an optimal weight might be obtained well before a full range of data has been considered. By data shuffling, the data contained in the training data sets 1006 can be analyzed more thoroughly and mitigate bias in the resultant machine learning model 1002.

Regularization is a training parameter that helps to prevent the machine learning model 1002 from memorizing training data from the training data sets 1006. In other words, the machine learning model 1002 fits the training data sets 1006, but the predictive performance of the machine learning model 1002 is not acceptable. Regularization helps the machine learning system 1000 avoid this overfitting/memorization problem by adjusting extreme weight values of the features 1008. For example, a feature that has a small weight value relative to the weight values of the other features in the training data sets 1006 can be adjusted to zero.

The machine learning system 1000 can determine model accuracy, recall, precision, receiver operating characteristic (“ROC”) area under the curve (“AUC”), and/or other desired metrics after training by using the training data sets 1006 with some of the features 1008 and testing the machine learning model 1002 with unseen evaluation data sets 1010 containing the same features 1008′ in the training data sets 1006. This also prevents the machine learning model 1002 from simply memorizing the data contained in the training data sets 1006, which can overfit the data. The optimal or desired machine learning system 1000 is reached when a target model accuracy or other desired metric threshold is met, which is understood through a model evaluation process in examining model performance on the evaluation data set 1010. Once a machine learning model 1002 has reached the desired metric threshold or optimal performance, the machine learning model 1002 is considered ready for deployment.

After deployment, the machine learning model 1002 can perform a prediction operation (“prediction”) 1014 with an input data set 1012 having the same features 1008″ as the features 1008 in the training data sets 1006 and the features 1008′ of the evaluation data sets 1010. The results of the prediction 1014 are included in an output data set 1016 consisting of predicted data. The machine learning model 1002 can perform other operations, such as regression, classification, and others. As such, the example illustrated in FIG. 10 should not be construed as being limiting in any way.

Based on the foregoing, it should be appreciated that concepts and technologies directed to an extended reality safety and accessibility assistant have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A method comprising:
receiving, by a server computer comprising a processor executing a safety and accessibility assistant service, a request from a user device, wherein the request comprises an image of a physical environment;
identifying, by the server computer, a structure within the image;
determining, by the server computer, whether the structure is associated with a rating; and
in response to determining that the structure is associated with a rating, generating, by the server computer, extended reality display data, wherein the extended reality display data comprises an augmented reality object that is representative of the rating.

2. The method of claim 1, further comprising providing, by the server computer, the extended reality display data to the user device so that the user device can present the augmented reality object.

3. The method of claim 2, wherein the augmented reality object is to be presented as an overlay of the image of the physical environment.

4. The method of claim 1, wherein identifying, by the server computer, the structure within the image comprises identifying a playground equipment within the image.

5. The method of claim 1, wherein determining, by the server computer, whether the structure is associated with a rating comprises determining, by the server computer, whether the structure is associated with a safety rating.

6. The method of claim 1, wherein determining, by the server computer, whether the structure is associated with a rating comprises determining, by the server computer, whether the structure is associated with an accessibility rating.

7. The method of claim 1, wherein determining, by the server computer, whether the structure is associated with a rating comprises querying a ratings database comprising a plurality of ratings associated with a plurality of structures.

8. The method of claim 7, wherein the plurality of ratings associated with the plurality of structures are determined, at least in part, based upon a machine learning model.

9. A system comprising:
a processor; and
a memory comprising computer-executable instructions that, when executed by the processor, cause the processor to perform operations comprising
receiving a request from a user device, wherein the request comprises an image of a physical environment,
identifying a structure within the image,
determining whether the structure is associated with a rating, and
in response to determining that the structure is associated with a rating, generating extended reality display data, wherein the extended reality display data comprises an augmented reality object that is representative of the rating.

10. The system of claim 9, wherein the operations further comprise providing the extended reality display data to the user device so that the user device can present the augmented reality object.

11. The system of claim 10, wherein the augmented reality object is to be presented as an overlay of the image of the physical environment.

12. The system of claim 9, wherein identifying the structure within the image comprises identifying a playground equipment within the image.

13. The system of claim 9, wherein determining whether the structure is associated with a rating comprises determining whether the structure is associated with a safety rating.

14. The system of claim 9, wherein determining whether the structure is associated with a rating comprises determining whether the structure is associated with an accessibility rating.

15. The system of claim 9, wherein determining whether the structure is associated with a rating comprises querying a ratings database comprising a plurality of ratings associated with a plurality of structures.

16. The system of claim 15, wherein the plurality of ratings associated with the plurality of structures are determined, at least in part, based upon a machine learning model.

17. A computer-readable storage medium comprising computer-executable instructions that, when executed by a processor, cause the processor to perform operations comprising:
receiving a request from a user device, wherein the request comprises an image of a physical environment;
identifying a structure within the image;
determining whether the structure is associated with a rating; and
in response to determining that the structure is associated with a rating, generating extended reality display data, wherein the extended reality display data comprises an augmented reality object that is representative of the rating.

18. The computer-readable storage medium of claim 17, wherein the operations further comprise providing the extended reality display data to the user device so that the user device can present the augmented reality object as an overlay of the image of the physical environment.

19. The computer-readable storage medium of claim 17, wherein identifying the structure within the image comprises identifying a playground equipment within the image.

20. The computer-readable storage medium of claim 17, wherein determining whether the structure is associated with a rating comprises determining whether the structure is associated with a safety rating, an accessibility rating, or both.
